(19) United States
(12) Patent Application Publication
(10) Pub. No.: US 2023/0254701 A1
(43) Pub. Date: Aug. 10, 2023

(54) Method and Apparatus for Support of Interference Coordination Groups and Sub-Groups

(71) Applicant: Celona, Inc., Campbell, CA (US)

(72) Inventors: Sourav Bandyopadhyay, Liluah Howrah (IN); Srinivasan Balasubramanian, San Diego, CA (US)

(21) Appl. No.: 18/075,974

(22) Filed: Dec. 6, 2022

Related U.S. Application Data
(60) Provisional application No. 63/286,464, filed on Dec. 6, 2021.

(51) Int. Cl. H04W 16/12

(52) U.S. Cl. CPC H04W 16/12

(57) ABSTRACT

A method of defining a Site to constitute one more interference coordination group (ICG). Additionally defined a Site to be constituted of Sub-Sites and defining ICSG (interference coordination sub-group), allowing a given access point from a ICG to belong to one or more ICSG. A method of aggregating the channel quality information determined by information provided from the SAS (Spectrum Access System) and Probe UE (User Equipment) to define ICG and ICSG. Providing a preferred ordered list of channels for ICG and each ICSG, further adapting the SON (Self Organizing Network) algorithm to use the channel allocations received for ICG and ICSG to perform optimized allocations. Continuously perform the Channel quality assessment and ICG/ICSG determination and rebalance the channel allocation based current, predicted, time-series, and know events for optimized operation.

### CLAIM OF PRIORITY TO PREVIUOSLY FILED PROVISIONAL APPLICATION—INCORPORATION BY REFERENCE

This non-provisional application claims priority to an earlier-filed provisional application No. 63/286,464 filed Dec. 6, 2021, entitled “Method and Apparatus for Support of Interference Coordination Group and Sub-Groups” (ATTY DOCKET NO. CEL-053-PROV) and the provisional application No. 63/286,464 filed Dec. 6, 2021, and all its contents, are hereby incorporated by reference herein as if set forth in full.

### BACKGROUND

### (1) Technical Field

The disclosed method and apparatus relate generally to systems for managing spectrum allocation. In particular, the disclosed method and apparatus relate to support of interference coordination groups and sub-groups.

### (2) Background

A SON (Self Organizing Network) can manage spectrum allocation for a group of Base Stations/Access Points (CBSDs). Some CBSDs may not have the same channel quality. However, the SON does not account for such differences.

Accordingly, it would be advantageous to provide a system that can separately manage spectrum allocation for different CBSDs.

### SUMMARY

Various embodiments of a method and apparatus for support of interference coordination groups and sub-groups are disclosed.

In some embodiments, Sub-Sites are defined within a site. ICSGs (Interference Coordination Sub-Groups) are defined. A given BS/AP (Base Station/Access Point) is allowed to belong to one or more ICSGs. Information is determined and aggregated by probe UEs (User Equipment) to define ICGs (Interference Coordination Groups) and ICSGs. A preferred order in which to list channels for an ICG and each ICSG is provided. A SON (Self-Organizing Network) algorithm is adopted to use the channel allocations received for ICG and ICSG to optimize bandwidth allocation. Channel quality is continuously assessed. The ICGs/ICSGs are redetermined and the channel allocation is rebalanced based on the assessment, the current flow, predicted flow, time-series, and known events to optimize or improve operations.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 illustrates an overview of a method and an apparatus for support of interference coordination group and sub-groups.

FIG. 2 illustrates two classes of eNBs (evolved node bases).

FIG. 3 illustrates the group notion in SAS (Spectrum Access System).

FIG. 4 illustrates an example of channel quality feedback from a SAS.

FIG. 5 illustrates an example of a sub-group partition formation based on a deployment plan for the system of FIG. 4.

FIG. 6 shows an example of a process in accordance with one embodiment of the disclosed method and apparatus.

FIG. 7 illustrates an example of creating a site.

FIG. 8 illustrates a flowchart for an embodiment of a method of adding a site.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

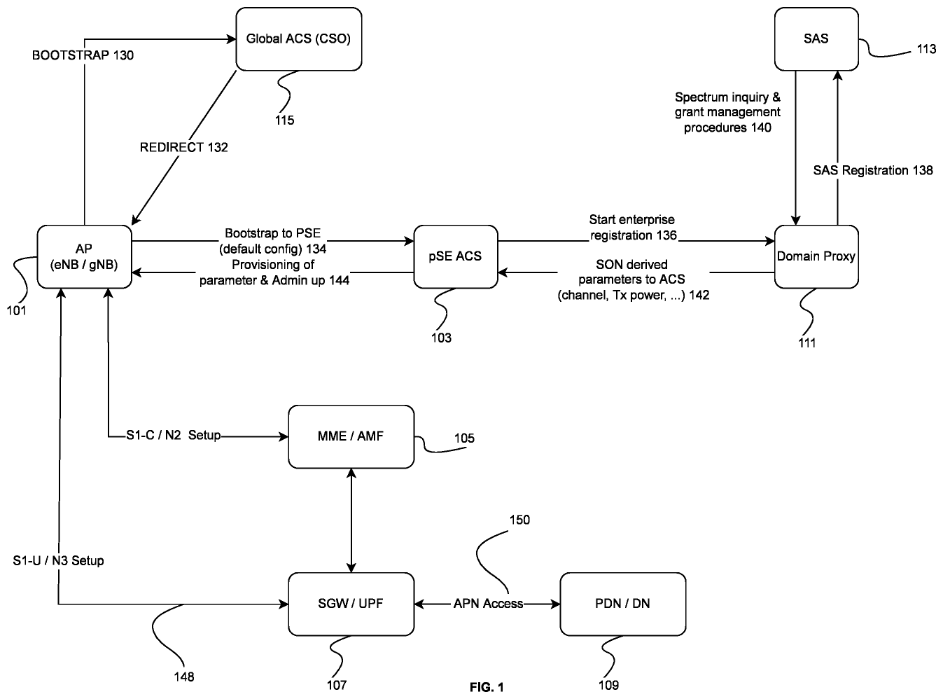

FIG. 1 illustrates an overview of an apparatus for support of interference coordination group and sub-groups. In an embodiment in which the network is configured essentially in accordance with the 3GPP (Third Generation Partnership Project) standard for fourth generation (4G) LTE (Long Term Evolution) networks. It should be understood that the disclosed method and apparatus applies equally well to 5G (5^{th} generation) NR (New Radio) network configurations.

FIG. 1 shows an architecture and outlines a process. Initially, a bootstrap procedure 130 is performed for a global ACS (Adjacent Channel Selectivity) 115. A redirect procedure 132 is performed to redirect to a pSE ACS (Packet Switched Entity ACS) 103. In some embodiments the redirect 132 includes one or more PLMN (Public Land Mobile Network) Ids, Cell identities, and PSE addresses, for example. A bootstrap procedure 134 to a PSE 103 has a default configuration. Next, enterprise registration 136 is started. A SAS (Spectrum Access System) 113 then performs a registration procedure 138. Next, spectrum inquiry and grant management procedures 140 are performed. A SON (Self-Organizing Network) (not shown) derives parameters, that are provided 142 to the pSE ACS 103. The pSE ACS 103 may include transmit powers and a channel for a message (or a flow), for example. Provision parameters and “Admin up” are provided 144 by the pSE ACS 103 to the AP 101 (e.g., an evolved Node Base (eNB) or gNodeB (gNB)). Next a MME (Mobility Management Entity) registration procedure occurs 146. A data path 148 is provided between the AP 101 and SGW (Serving Gateway)/UPF (User Plane Function) 107. A data path 150 is also provided between the SGW/UPF and the PGW (Packet Gateway)/Data Network (DN) 109.

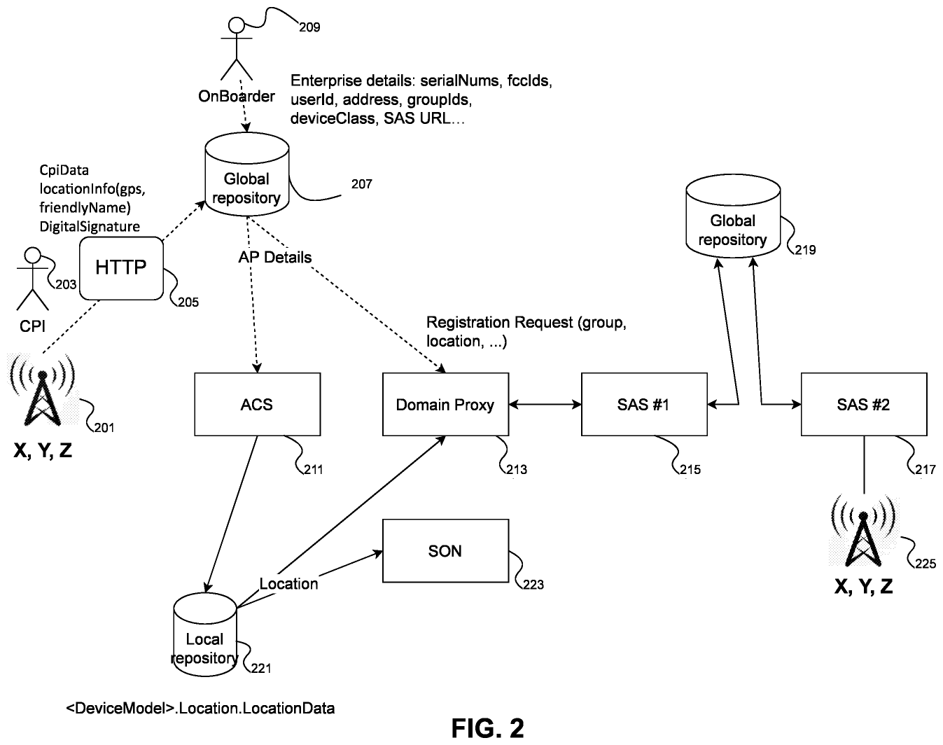

FIG. 2 illustrates CBSDs (Citizen Broadband radio Service Devices) implemented as eNBs/gNBs 201 in a CBRS (Citizen Broadband radio Service) enterprise network. Class-B CBSDs require a CPI (Certified Professional Installer) 203 to provide information used by a DP (Domain Proxy) 213 to register the CBSD 201 during installation. Class-A devices: (1) cannot self-locate; and (2) are installed 6 meters AGL (Above Ground Level). Such Class-A CBSDs require a CPI for installation. If multiple CBSDs 201 are present in an enterprise, the SAS 215 can accept a “group” and allow a local arbitrator to provide coordination functions. In some embodiments, enterprise details provided by the CPI 203 include: (1) the serial number (serialNums); (2) Federal Communications Commission Identifier (fccIds); (3) User Id (userID); (4) address; (5) Group Identifier (groupIds); (6) Device Class (deviceClass); and (7) SAS Universal Resource Locator (URL), for example.

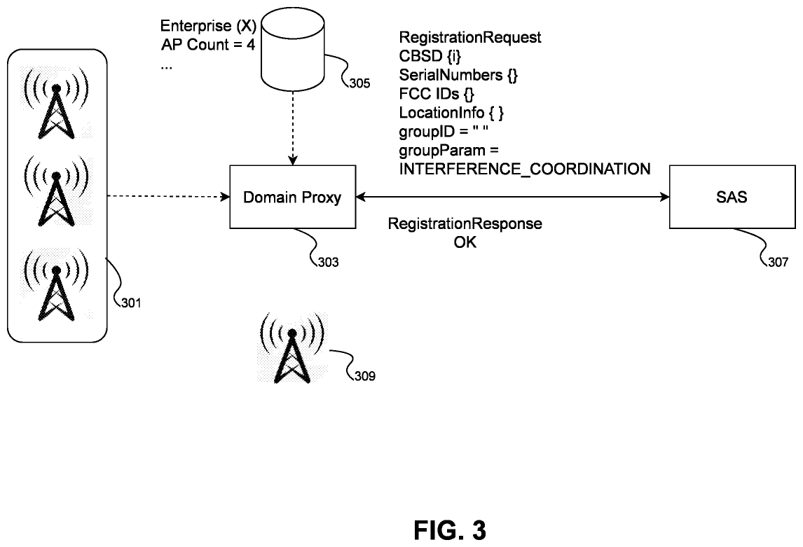

FIG. 3 illustrates a DP 303 and SAS 307 in which a groupID is provided in a registration request. A group parameter (groupParam) is set to an Interface coordination value. DPs 303 serve several purposes, two of which are to: (1) limit number of Transport Layer Security (TLS) connections to a SAS 307, and (2) arbitrate and perform certain algorithmic functions (e.g., channel selection).

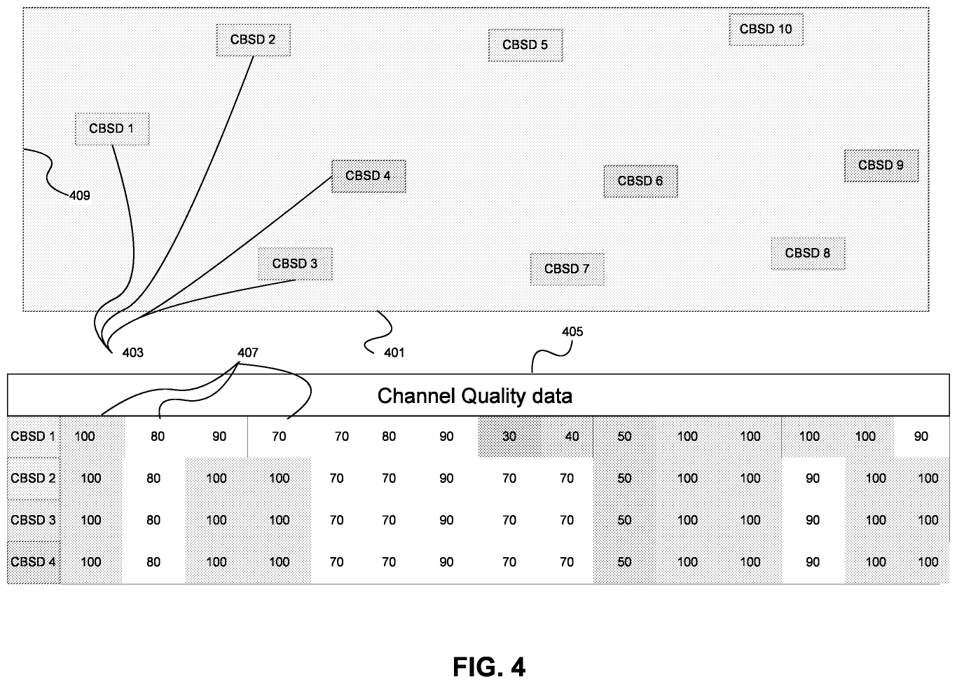

FIG. 4 illustrates an example of channel quality feedback provided by a SAS. The top portion of the figure illustrates the relative locations of several CBSDs 401, which in the example shown are implemented as CBSDs 403. The bottom portion of the figure illustrates the values returned for the CBSDs 403. Each column of numbers 407 in table 405 indicates the quality of the channel indexed from 1 to 15 in 10 MHz chunks in the CBRS band. In some embodiments, channel quality information is provided from the SAS on a per CBSD basis. The particular color shown for each of the values 407 indicate a quality level on scale from 1 to 100 with 1 being very low quality and 100 being very high quality. That is, channels with a quality value of 100 have a different color than the channel with a quality level of 90, which are a different color from those with a level of 80, etc.

In the channel quality map of the example of FIG. 4, CBSD 1 is near an open wall 409 and therefore sees a deterioration of the channel quality for some channels. For a system in which a channel quality threshold is set to a value of 50, CBSD 2, 3, and 4 are inside the walls, and therefore see channel quality above the threshold for all channels (e.g., the values are greater than or equal to 50). However, at least two of the channels of CBSD 1 are below the threshold.

In some embodiments, the SAS provides the channel quality information only for a subset of the channels to CBSD or for the ICG (Interference Coordination Group) supporting a set of CBSDs within a site.

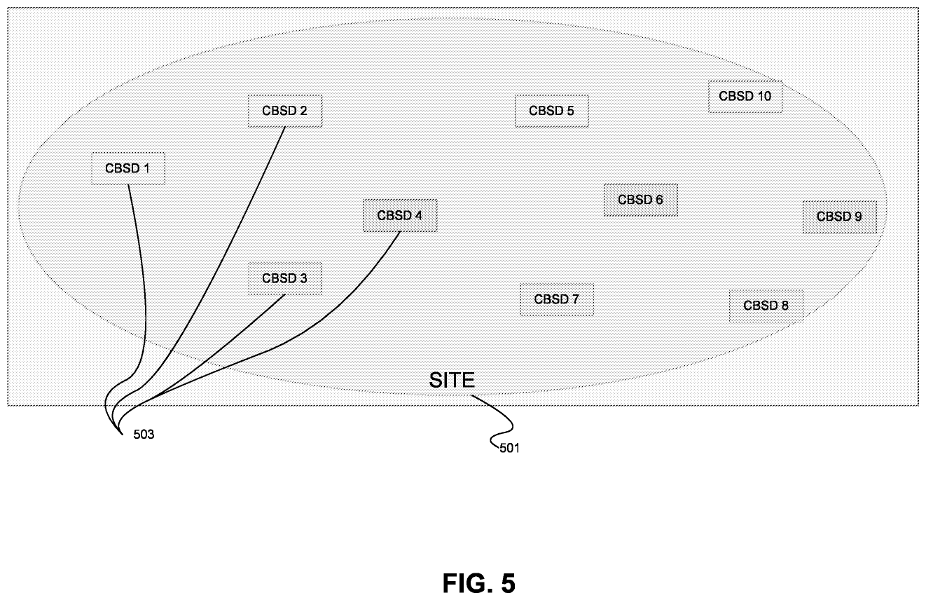

FIG. 5 illustrates an example of a sub-group partition formation based on a deployment plan for the system of FIG. 4. In this example, all of the CBSDs are located within one Site 501. Accordingly, they all belong to one ICG. However, CBSD 1 is in a sub-group by itself, CBSDs 2, 5 and 10 are in a second sub-group, CBSDs 4, 6 and 9 are in a third sub-group and CBSDs 3, 7 and 8 are in a fourth sub-group.

In some embodiments, a two-part implementation is carried out. Quality thresholds are established. In a first part of the two-part implementation, a User Interface (UI) sends alerts to customers when either: (1) a probe User Equipment (UE), such as a smart phone used to make channel quality measurements; or (2) a SAS channel quality for a CBSD, is lower than the thresholds. In some embodiments, channel quality is computed using the formula in Equation-1 (EQ-1):

Q_{Channel}=Σ_{i=1 to 15}ω_{SAS}*SASCQᵢ+ω_{ProbUECQ}_{ᵢ}*ProbeUECQᵢ: {EQ-1}

where:
Q_{channel} is the assessed aggregate quality of the 15 channels available to a CBSD
ω_{SAS} is the channel weight for a SASCQᵢ based channel quality reported from SAS;
SASCQᵢ is the channel quality from SAS for channel I;
ω_{ProbUE} is the channel weight for a probe UE based channel quality; and
ProbeUECQᵢ (Probe UE Quality) is the channel quality report from the probe UE;
where:
   The SASCQᵢ and ProbeUECQᵢ are normalized to single scale; and
   Typically, the ω_{SAS}+ω_{ProbUE}=1 to accommodate scenarios when either the SAS or the Probe UE measurements are not available for a given CBSD or a normalization function applied to Q_{channel} after computation.

In some embodiments, only the quality information from the SAS is available and the Q_{channel} is assessed as defined in formula Equation-2 (EQ-2)

Q_{Channel}=Σ_{i=1 to 15}SASCQᵢ: {EQ-2}

In some embodiments, only the quality information from the probe UE is available and the Q_{channel} is assessed as is defined in formula Equation (EQ-3)

Q_{Channel}=Σ_{i=1 to 15}ProbeUECQᵢ: {EQ-3}

In some embodiments, the 0 Channel is assessed on a subset of the channels based on the allowed set of the channel for operation by the SAS for an individual CBSD 503 or for the full Site 501.

In some embodiments, in a second part of the two-part implementation, the thresholds are used by a SON algorithm to reallocate channels on the same Site or change Site configurations. In other words, the SON algorithm reallocates channels or changes the Site configuration when the thresholds are crossed.

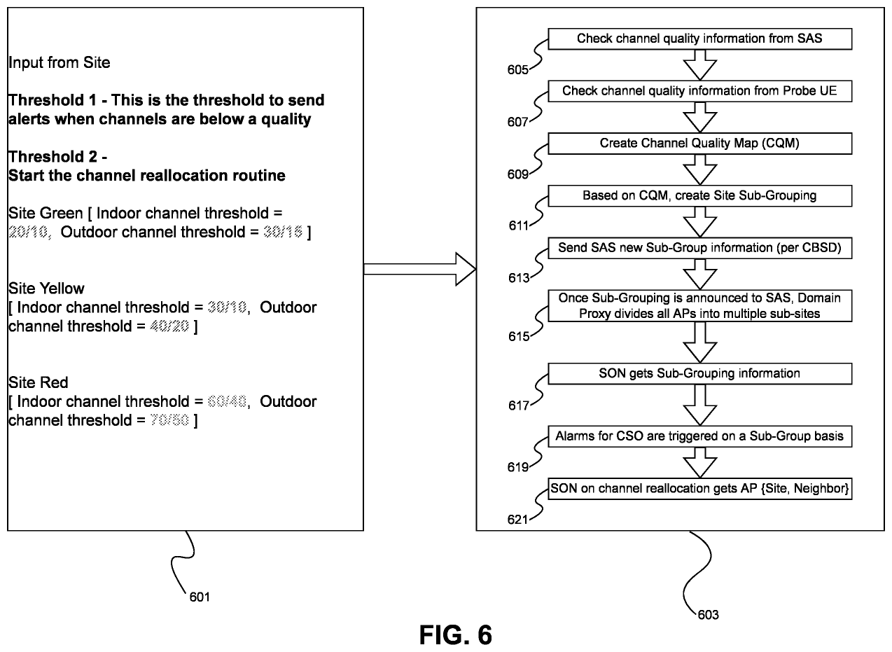

FIG. 6 shows an example of a design. As illustrated by the threshold transitions shown in 601 and the logic shown in 603, when the channel quality crosses threshold 1 (e.g., falls below threshold 1), alerts are sent to SON to get prepared for channel reallocations. When the channel quality further drops below threshold 2, a channel reallocation routine is started. In some embodiments, when thresholds 1 and 2 are crossed for individual CBSDs, the following actions are taken. Channel quality information is requested from SAS and is checked as shown in 605. Channel quality information is requested from Probe UE and is checked as shown in 607. A CQM (Channel Quality Map) is created, based on the formula defined in {EQ1} as shown in 609. Based on the CQM associated with the individual channels for each of the deployed CBSDs in the site and the relative position of the CBSDs within the deployment, sub-groupings are created as shown in 611. New sub-group information is sent to the SAS or a per CBSD basis as shown in 613. Once grouping is announced to SAS, in some embodiments, the Domain Proxy (DP) divides all CBSDs in the site into multiple Sub-Sites as shown in 615. Sub-group information is provided to the SON as shown in 617. Alarms for orchestration layer is triggered based on Sub-Group information as shown in 619. Upon channel reallocation, the SON receives BS/AP information, e.g., AP {site-info, neighbor-site-info} as shown in 621.

### Site and Sub-Site Definition

A site is a collection of CBSDs that is reported as belonging to an ICG for the SAS. When the SAS provides spectrum allocation, the allocated channels are available to be used in any of the CBSDs that belong to the ICG. A Sub-Site is a logical grouping of a subset of the CBSDs that belong to a given Site. In some embodiments, one of the purposes of having Sub-Sites is to allow for improved spectrum allocation to the individual Sub-Sites within a given Site from a SAS while still relegating the spectrum management of the entire Site to the SON deployed in the enterprise. Based on dynamic changes in the environment and use cases, the definition and constitution of the Sub-Site can and will change.

### Determination of a Sub-Site

In some embodiments, the constitution of a Sub-Site is determined based on several factors, which include (1) Radio Environment Measurements (REM) and determining the interference experienced networks deployed in the vicinity of each CBSD; (2) use cases for the individual CBSD UL (e.g., video security camera; Uplink (UL) centric versus Downlink (DL) centric traffic), (3) a location within the building (e.g., proximity to an adjoining building supporting another Citizen Broadband Radio Service (CBRS) network, extremities of the building versus inside the building, the floor level where the CBSD is deployed, for example), (4) the channel type usage (e.g., General Available Access (GAA) versus Priority Access License (PAL), Category—A (CAT-A) versus Category—B (CAT-B) cells—a Sub-Site can itself consist of CAT-B only, CAT-A+CAT-B or CAT-A only), (5) whether the BS/AP supports only Long Term Evolution (LTE), only New Radio (NR), or both LTE and NR, and (6) whether the transmission levels of the CBSDs are allowed to be adapted (e.g., changed) on a subSite basis.

Statistical Analysis of Channel Quality from Probe UE and Dynamically Change Channel Powers for CBSDs

In some embodiments, the channel quality is checked, and data indicative of the channel quality is accumulated and collected from a probe UE at regular intervals. Based on handovers and the channel quality information, a check is performed to determine whether there is any increase or decrease of interference or coverage overlaps. The CBSD power is adjusted based on the relations (e.g., the interferences and overlap of coverage) and the data collected. This data is stored for use when similar scenarios arise and/or when more handover failures or coverage gaps are detected. This predictive nature (e.g., how to adjust the power to decrease coverage gaps and handover failures) is addressed based on predicted trends and historical information, instantaneous values, time-series data, and known events with specific use cases and scheduled changes.

### ICG and Interference Coordination Sub-Group (ICSG) Interface to SAS

In some embodiments, CBSDs within a Site are reported as part of a single ICG to the SAS from (or by) the CBSD/DP. Based on the Sub-Site groupings identified as part of a site, optionally, the CBSD/DP indicates the CBSDs of each given Sub-Site of a Site to be part of an ICSG in a request to a SAS. A given Sub-Site may have one or more CBSDs in it. Any given CBSD can belong to one or more Sub-Sites. The intersection (e.g., of Sub-Sites or CBSD and subsites) is used to represent (e.g., determine) scenarios of transition points between two Sub-Sites.

### ICG & ICSG

There can be zero or more ICSGs in an ICG. However, in some embodiments, any given ICSG can belong to only one ICG at a given time.

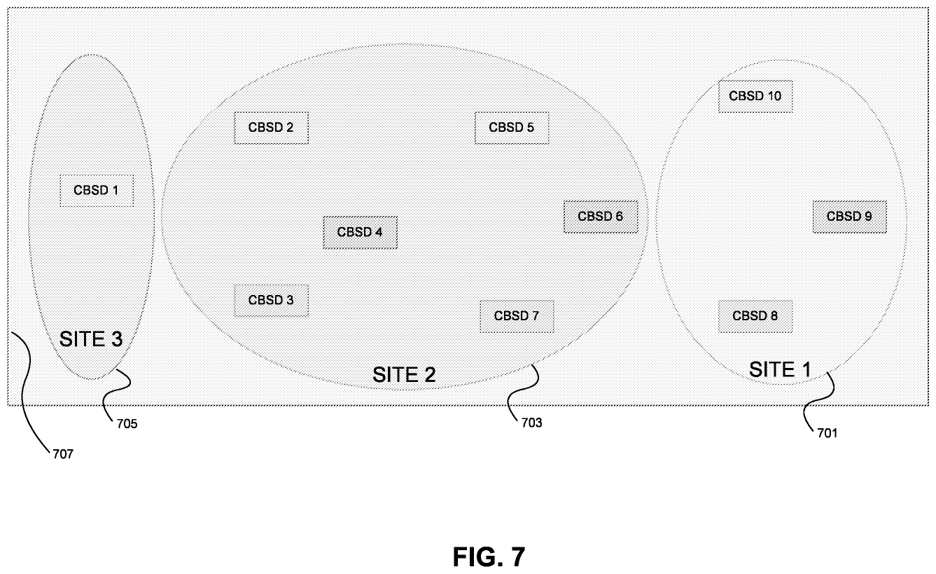

FIG. 7 illustrates creating a site. In the example of FIG. 7, CBSD 1 in a third Site 705 is near an open wall 707 and sees channel quality deteriorated for specific channels. CBSD 2, 3, and 4 in a second Site 703 are inside the walls and see channel quality above the threshold for all channels. In FIG. 7, the second Site 703 will have the least impact on external interference. A first Site 701 may be adjacent to the wall, and so interference is low, but can be impacted by external interference. The third Site 705 has the highest amount of interference, needs to be monitored more stringently. The third Site 705 will have more channel reallocation use cases than the first Site 701 and the second Site 703.

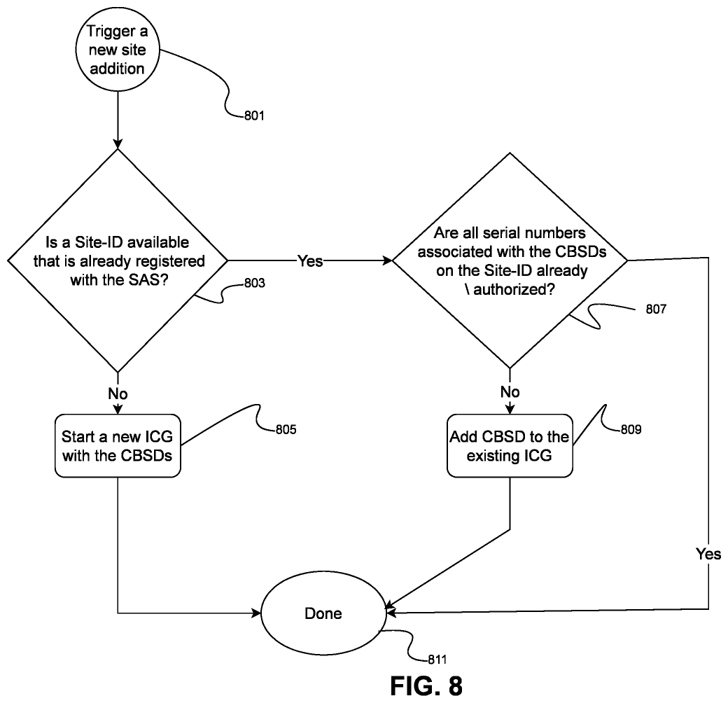

FIG. 8 illustrates a flowchart for an embodiment of a method of adding a site. The trigger for adding a Site is shown in 801. Check if an unused Site-ID is available that is already registered with the SAS as shown in 803. If answer to 803 is no, start a new ICG with the CBSDs as shown in 805 and process for adding a Site is complete. If answer to 803 is yes, check if all serial numbers associated with the CBSDs on the Site-ID already authorized as shown in 807. If answer to 807 is no, add CBSD to existing ICG as shown in 809 and process for adding a Site is complete. If answer to 807 is yes the process for adding a Site is complete and no additional steps are required.

### Initial Site Creation Loop of the Method of FIG. 8

In some embodiments, the initial Site loop, the orchestration layer creates an initial set of sites based on SON output and initial channel planning. In some embodiments, all CBSDs in a given Site are added to a new ICG and are authorized to transmit. Once the sites are up (e.g., running), channel quality information is captured. The channel quality assessment may be based on the channel quality information captured for each CBSD. In some embodiments, the definition for a Site and the constitution of Sub-Sites within each Site are determined. ICG/ICSG groups are formed for each Site of a given channel. In some embodiments, quality information is captured for each CBSD. The CBSDs can be added to Sub-Sites based on the quality information captured.

### Feedback Loop for Dynamic Changes of the Method of FIG. 8

Channel allocation for sites/Sub-Sites is requested, by DP requests, from the SAS. Upon any replanning, the channel quality assessment and ICG/ICSG determination are continuously reperformed. Upon triggering thresholds for channel change, the SON evaluates whether the channels need to change and whether a new Site group should be formed. Thresholds were discussed above as part of the discussion of FIG. 6.

### Changes in API for SAS

Below is a portion of pseudocode pertaining to changes in the API of a SAS.

“groupingParam”: [ {
“groupId”: “group-1”,
“groupType”: “INTERFERENCE_COORDINATION”
},
{ “sub-grouped”: “sub-group-1”,
“groupType”: “SUB-GROUP MANAGEMENT”
},
{ “sub-groupId”: “sub-group-2”,
“groupType”: “SUB-GROUP MANAGEMENT”
}
]

The inclusion of one or more sub-groups is optional. Zero or more sub-groups can be specified within any given group. The group and sub-groups can change dynamically as the Site environment changes or as different use cases arise.

### SAS Channel Allocation

The SAS responds to the request for ICGs and ICSGs by providing an appropriate channel allocation. The channel allocation provided by the SAS can take the below forms.

In some embodiments, a single allocation of channels is provided for the full ICG. In some embodiments, allocations for individual ICSGs are provided. In some embodiments, an allocation for an ICG that applies to all CBSDs in the ICG is provided. Additionally, a grant of specific channels to specific ICSGs in the ICG is provided. This could include additional allocations for all ICSGs in the ICG, with each ICSG being provided a different set of channels.

### Probe UE

A probe UE is a UE that is deployed on a campus and can be used to read SIBs (System Information Blocks) of CBSDs on and near a site. The signal strength of the CBSDs is measured. Connectivity to specific CBSDs is measured by forcing throughput (through the connection), and delay performance is measured.

One or more probe UEs may be deployed temporarily or permanently on a campus. In some embodiments, the individual probe UEs are in a static location and potentially moved to different locations at different points in time or are used as a mobile device with an individual walking the campus with the device. The information reported by the probe UEs is used to determine (1) the ranking of the channels for the ICG and (2) the channel's ranking for the individual ICSG.

### SON Algorithm Changes

The SON algorithm is based on received channel quality information. In some embodiments, the SON algorithm (1) accumulates CQ information and trends from SAS, (2) accumulates CQ information from probe UEs, and (3) accumulates individual UE performance data. The SON algorithm checks for thresholds to trigger events. In some embodiments, channel reallocation and Site reconfiguration are scheduled based on thresholds and customer inputs.

Reallocation for new Site groups can be more conservative based on the location of the site. Based on the replanning of the sites and Sub-Sites, the SON replans the channel allocation for the individual CBSDs.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a) a processor;
b) a memory system having a non-transitory computer-readable medium storing one or more computer instructions, which when implemented cause the processor to
i) designate a collection of access points as a Site that report as an interference coordination group to spectrum access system, wherein channels to the interference coordination group; and
ii) designating a subgroup of the designated access points as a Sub-Site, based on network conditions, the Sub-Site being allocated spectrum separately from other parts of the Site;
wherein spectrum management for the Site and the Sub-Site is managed by a common self-organizing network algorithm.

2. The system of claim 1, further including allowing a given CBSD to belong to one or more ICSG.

3. The system of claim 1, wherein the Site is provided spectrum allocation from a SAS (Spectrum Access System) to the interference coordination group.

4. The system of claim 3, wherein the Sub-Site is provided an independent spectrum allocation from the SAS for use by a subset of the CBSDs in the interference coordination group.
